(19) United States
(12) Patent Application Publication
(10) Pub. No.: US 2026/0261956 A1
(43) Pub. Date: Sep. 3, 2026

(54) MESH NETWORK WITH MULTI-PROTOCOL COMMUNICATIONS

(71) Applicant: Silicon Laboratories Inc., Austin, TX (US)

(72) Inventors: Hasan Ali Stationwala, Hyderabad (IN); Atul Joshi, Pune (IN); Jori Henrik Rintahaka, Espoo (FI); Gustavo Guillermo Hernandez, Austin, TX (US)

(21) Appl. No.: 19/066,311

(22) Filed: Feb. 28, 2025

(51) Int. Cl. H04W 40/24; H04W 24/02; H04W 84/18

(52) U.S. Cl. CPC H04W 40/248; H04W 24/02; H04W 84/18

(57) ABSTRACT

A method for operating a wireless mesh network of nodes includes receiving packets from a mesh network stack of a first wireless communications protocol executing on a bridge node of the wireless mesh network. The method includes translating the packets from the first wireless communications protocol to a second wireless communications protocol by the bridge node, thereby generating translated packets. The method includes transmitting the translated packets by the bridge node using the second wireless communications protocol. The second wireless communications protocol has higher data throughput than the first wireless communications protocol. Translating the packets may include assembling a plurality of segments of the packets in a concatenated segments field of a concatenated segments packet data unit of the translated packets.

### BACKGROUND

### Field of the Invention

This disclosure relates to communications systems in general, and more particularly to local area networks of radio frequency (RF) communications systems.

### Description of the Related Art

In general, each node in mesh network is able to communicate with every other device in the mesh network. Existing protocols for wireless mesh networks (e.g., BLE Mesh and OpenThread) have limited peak throughput capabilities. Higher throughput wireless mesh networks, e.g., a Wi-Fi mesh protocol defined by IEEE 802.11s, are not widely deployed in the Internet of Things or other applications and are not tailored to low power, inexpensive devices. Other communications protocols provide a tree-based, Wi-Fi range extender solution for its IoT devices. Each device supports configuration as a Wi-Fi wireless access point (AP) and a Wi-Fi wireless client or station (STA). Devices that are configured to be repeaters for range extension are required to be always beaconing and all communications use Internet Protocol (IP), which requires maintaining an IP stack for repeaters and consumes substantial computing resources and power for small data transfers. Still other solutions use a proprietary mesh network on top of Wi-Fi transport but do not have any power saving mechanisms. Accordingly, improved techniques for implementing a wireless mesh network are desired.

### SUMMARY OF EMBODIMENTS OF THE INVENTION

A method for operating a wireless mesh network of nodes includes receiving packets from a mesh network stack of a first wireless communications protocol executing on a bridge node of the wireless mesh network. The method includes translating the packets from the first wireless communications protocol to a second wireless communications protocol by the bridge node, thereby generating translated packets. The method includes transmitting the translated packets by the bridge node using the second wireless communications protocol. The second wireless communications protocol has higher data throughput than the first wireless communications protocol. Translating the packets may include assembling a plurality of segments of the packets in a concatenated segments field of a concatenated segments packet data unit of the translated packets. The method may include receiving second packets from a second node of the wireless mesh network by the bridge node using the second wireless communications protocol. The method may include identifying the second packets as being communicated using the second wireless communications protocol in response to detecting at least one concatenated segments packet data unit in the second packets. The method may include translating the second packets from the second wireless communications protocol to the first wireless communications protocol by the bridge node partitioning a plurality of segments in a concatenated segments field of the at least one concatenated segments packet data unit into protocol data units of second translated packets. The method may include providing the second translated packets to the mesh network stack. The method may include receiving additional packets from the mesh network stack and transmitting the additional packets by the bridge node using the first wireless communications protocol. The translated packets may be data packets and the additional packets may be control packets. The method may include establishing friendship with a second node using the first wireless communications protocol, buffering data destined for the bridge node by the second node during a low power state of operation, and disabling communications using the second wireless communications protocol by the bridge node in the low power state of operation and communicating radio frequency signals using the first wireless communications protocol in the low power state of operation. The method may include enabling communications using the second wireless communications protocol by the bridge node in response to pending data for communication via the second wireless communications protocol

In at least one embodiment, an apparatus includes a multi-protocol node including a first physical layer of a first protocol stack, a second physical layer of a second protocol stack, and a subnetwork filter. The first physical layer is configured to communicate radio frequency signals using a first wireless communications protocol. The second protocol stack is configured to communicate second radio frequency signals using a second communications protocol. The subnetwork filter is configured to receive a stream of packets from a mesh network stack, translate first packets of the stream of packets from the first wireless communications protocol to the second wireless communications protocol, and cause the second physical layer to transmit translated packets using the second wireless communications protocol.

The subnetwork filter may be configured to receive concatenated segments fields of second packets from the second physical layer, partition a plurality of segments in each of the concatenated segments fields, and provide each segment of the plurality of segments to the mesh network stack. The subnetwork filter may be configured to receive additional packets from the mesh network stack and provide the additional packets to a controller of transmission using the first wireless communications protocol. The translated packets may be data packets and the additional packets may be control packets. The apparatus may include a second node associated with a first subnetwork of a wireless mesh network of nodes and may be configured to communicate using the first wireless communications protocol and the first predetermined network key index. The apparatus may include a third node associated with a second subnetwork of the wireless mesh network and may be configured to communicate using the second wireless communications protocol and the second predetermined network key index. The multi-protocol node may be configured to disable the second physical layer in a low power state of operation and may be configured to communicate the radio frequency signals using the first physical layer in the low power state of operation. The second node may be configured as a friend node and to buffer data for transmission to the multi-protocol node during the low power state of operation.

In at least one embodiment, a method for operating a wireless mesh network includes receiving a packet from a first physical layer associated with a first wireless communications protocol. The method includes translating the packet from the first wireless communications protocol to a plurality of packets of a second wireless communications protocol by a bridge node of the wireless mesh network. The method includes providing a translated packet to a mesh network stack of the bridge node, the mesh network stack being associated with the second wireless communications protocol. The first wireless communications protocol has higher data throughput than the second wireless communications protocol. The method may include receiving a second packet from a second physical layer associated with the second wireless communications protocol and providing the second packet to the mesh network stack of the bridge node. The mesh network stack may be associated with the second wireless communications protocol. The method may include transmitting the translated packet to a third node of the wireless mesh network using the second wireless communications protocol. The third node may be associated with a second subnetwork of the wireless mesh network.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a plurality of wireless communications devices communicatively coupled in a mesh network using a personal area network communications protocol.

FIG. 2 illustrates a functional block diagram of an exemplary wireless communications device of FIG. 1.

FIG. 3 illustrates an exemplary BLE controller of the exemplary wireless communications device of FIG. 2.

FIG. 4 illustrates an exemplary multi-protocol mesh network including a plurality of subnetworks and bridge nodes.

FIG. 5 illustrates a functional block diagram of an exemplary bridge node of FIG. 4.

FIG. 6 illustrates a format of a packet including a concatenated segments protocol data unit used by the multi-protocol mesh network.

The use of the same reference symbols in different drawings indicates similar or identical items.

### DETAILED DESCRIPTION

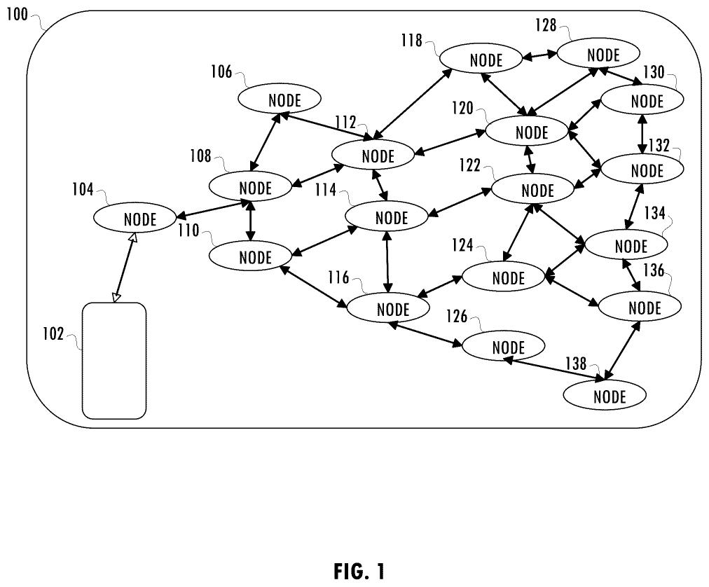

Referring to FIG. 1, IoT ecosystem 100 includes a conventional BLE mesh network of nodes in communication with wireless communications device 102. Wireless communications device 102 communicates with node 104 using a Generic Attribute Protocol (GATT) over a BLE link. Nodes 104, 106, 108, . . . 138 communicate with each other using a BLE protocol and establish the conventional BLE mesh network. In other embodiments, other protocols and other types of links may be used.

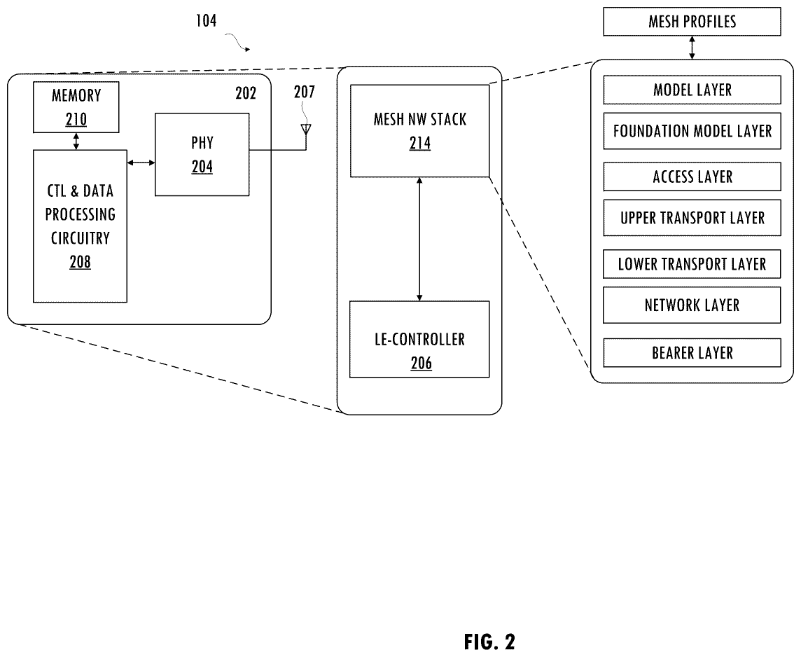

Referring to FIG. 2 in an embodiment, node 202 is an exemplary wireless communications node that includes control and data processing circuit 208, memory 210, physical interface 204 (e.g., radio frequency transmitter and receiver), and antenna 207. Control and data processing circuit 208 executes instructions to implement layers of the software protocol stack, e.g., LE-controller 206 and mesh network stack 214. In an embodiment, mesh network stack 214 includes various layers of software that provide network security, onboarding and configuration, network addresses, packet filtering, and routing consistent with a mesh network protocol (e.g., BLE mesh). For example, mesh network stack 214 implements layers described in Mesh Protocol Bluetooth® Specification Revision: v1.1, which describes requirements to enable interoperable mesh networking solution for Bluetooth Low Energy wireless technology. However, other mesh networking protocols may be used. In at least one embodiment, a receiver process of LE-controller 206 receiver is always on (e.g., executes BLE scanning for advertisement packets from other BLE devices) and a transmit process is enabled on demand (e.g., executes LE-advertisement).

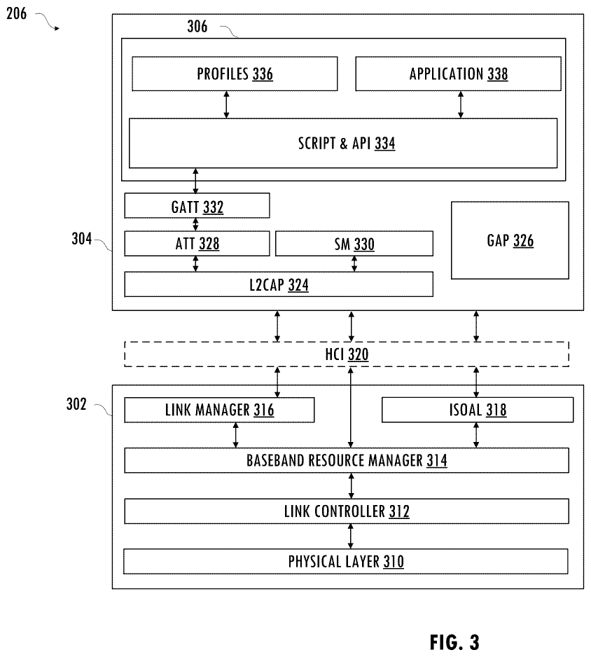

Referring to FIG. 3, in at least one embodiment of a wireless network, each node of the mesh network implements a BLE controller, e.g., using separate integrated circuit devices for controller 302 and host 304. In some embodiments, LE-controller 206 incorporates functionality of controller 302 and host 304 in a single integrated circuit device, although separate integrated circuit devices may be used.

In an embodiment, controller 302 includes physical layer 310 (e.g., RF radio) and link controller 312, which are responsible for sending or receiving packets over the air by defining the use of a radio, including modulation schemes, frequency bands, channel use, and transmitter and receiver characteristics, e.g., as described in Bluetooth Core Specification Version 5.3, Vol. 6: Low Energy Controller. Physical layer 310 transmits and receives packets of information using the physical channel and transforms a stream of data to and from the physical channel and the baseband signals into required formats. The physical layer defines the use of a radio (e.g., transmitter and receiver), including modulation schemes, frequency bands, channel use, and transmitter and receiver characteristics. Link controller 312 implements a link layer protocol, which defines the air interface packet formats, bit stream processing procedures, a state machine and protocols for over-the-air communication, and link control. Link controller 312 encodes and decodes packets including a data payload and parameters related to a physical channel, logical transport, and logical link.

Baseband resource manager 314 negotiates access contracts, i.e., commitments to deliver a predetermined Quality-of-Service (QoS) that is required by a user application to provide expected performance. Baseband resource manager 314 also includes a scheduler that grants time on physical channels to entities that have negotiated an access contract. Link manager 316 creates, modifies, and releases logical links (and associated logical transports, if required) and updates parameters related to physical links between devices. Isochronous adaptation layer 318 provides segmentation and reassembly, and fragmentation and recombination of packets to and from a higher layer. In an embodiment, LE-controller 206 implements Host-to-Controller Interface (HCI) 320, which is a standard service interface.

In an embodiment, host 304 includes Generic Framework (GF) 306, Logical Link Control and Adaptation Protocol (L2CAP) resource manager 324, Attribute Protocol (ATT) 328, Generic Attribute Protocol (GATT) 332, Generic Access Profile (GAP) 326, and Security Manager (SM) 330. L2CAP resource manager 324 manages ordering of submission of BLE packet protocol data unit (PDU) fragments and some relative scheduling between channels to ensure that L2CAP channels with QoS commitments are not denied access to the physical channel due to controller resource exhaustion. L2CAP resource manager 324 polices traffic to ensure that applications submit L2CAP Service Data Units (SDUs) within bounds of negotiated QoS settings. In an embodiment of LE-controller 206, GATT 332 defines the way that two BLE devices communicate data using services and characteristics. In an embodiment, GATT 332 uses a generic data protocol stored in ATT 328, which is used to store services, characteristics and related data in a simple lookup table using 16-bit identifiers for each entry in the table. SM 330 implements a peer-to-peer protocol for generating encryption keys and identity keys and generates random addresses and resolves random addresses to known device identities.

GAP 326 represents base functionality common to all Bluetooth devices, e.g., modes and access procedures used by transports, protocols, and application profiles. GAP services include device discovery, connection modes, security authentication, associate models and service discovery. GF 306 includes Script and API 334, application 338, and profiles 336, which adds application specific information to GF 306.

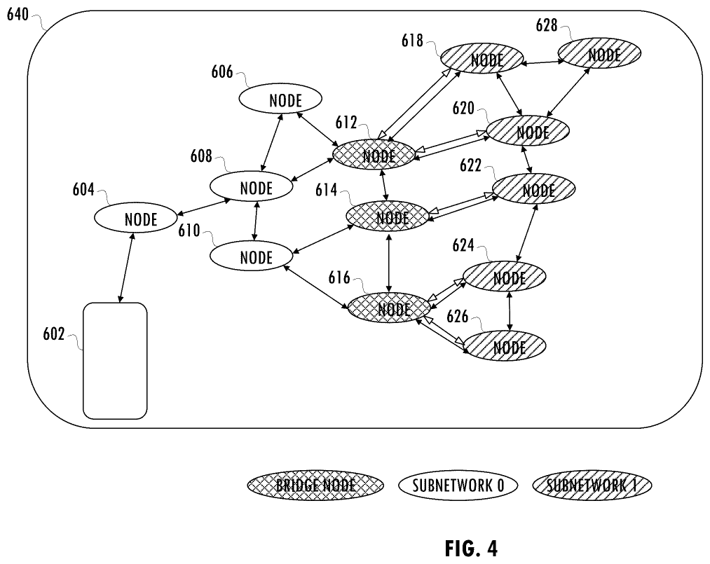

Referring to FIG. 4, in at least one embodiment, wireless communications device 602 serves as a mesh manager. That is, wireless communications device 602 is configured as a provisioner and a configuration manager to commission new devices into network 640 and to configure network 640. Wireless communications device 602 knows a device key corresponding to each node in network 640. Although wireless communications device 602 is the only provisioner in the illustrated embodiment of network 640, in other embodiments, network 640 includes at least one additional device configured as a provisioner. Network 640 includes multiple subnetworks. Each subnetwork is a portion of the network that is accessed using a unique network key. In an embodiment, each network key has an index (abbreviated herein), e.g., the network key with an index of ‘0’ is associated with subnetwork 0, the network key with an index of ‘1’ is associated with subnetwork 1, etc.

In an embodiment, network 640 includes subnetwork 0, which includes nodes 604, 606, 608, and 610), subnetwork 1, which includes nodes 618, 620, 622, . . . , and 628, and a bridge subnetwork, which includes nodes 612, 614, and 616. Nodes 612, 614, and 616 are configured as bridge nodes and communicate with nodes 618, 620, 622, 624, and 626, which are multi-protocol nodes. In an embodiment of network 640, one or more nodes implementing only the BLE mesh protocol, e.g., node 628, communicates with a multi-protocol node, e.g., node 618. In an embodiment, subnetwork 0 is a BLE subnetwork, subnetwork 1 is a BLE-over-Wi-Fi subnetwork, and the bridge nodes are nodes that translate messages between subnetwork 0 and subnetwork 1. In an embodiment, a bridge node identifies whether a mesh SDU received from a BLE physical interface of the bridge node is to be forwarded to a Wi-Fi physical interface based on routing decisions. Since the Wi-Fi protocol supports a larger PDU length, the bridge node may aggregate multiple smaller PDUs for communication as a single Wi-Fi PDU. In addition, the bridge node may partition a Wi-Fi PDU received using the Wi-Fi physical interface and may forward smaller SDUs to the BLE physical interface. In an embodiment, the bridge nodes are included in subnetwork 0 and subnetwork 1 and know the network keys for both subnetworks. A bridging configuration (e.g., a configuration determining which source addresses are allowed to communicate from one subnetwork to another subnetwork) is handled via a standard subnetwork bridging mechanism and additional semantics attached to a subnetwork index that allow bridging nodes to differentiate between an origination or destination physical interface without needing to change stack-internal application programming interfaces (APIs) throughout the stack to carry physical medium information, are described further below. In other embodiments, rather than using a subnetwork bridging mechanism to perform message translation, vendor-specific, out-of-band network information, or a vendor-specific, mesh model identifies a physical medium to be used by a node for communication of a message directed to a predetermined address.

In an embodiment, nodes included in subnetwork 1 are configured to send a mesh message to another node in subnetwork 1 using a Wi-Fi physical interface. The maximum network PDU size of subnetwork 1 (e.g., 394 bytes) is greater than the maximum network PDU size of subnetwork 0 (e.g., 29 bytes), the maximum transport PDU size of subnetwork 1 (e.g., 381 bytes) is greater than the maximum transport PDU size of subnetwork 0 (e.g., 16 bytes), and the maximum unsegmented access message size of subnetwork 1 (e.g., 380 bytes) is greater than the maximum unsegmented access message size of subnetwork 0 (e.g., 15 bytes). Subnetwork 1 and subnetwork 0 have the same maximum access payload size (e.g., 380 bytes, excluding Message Integrity Check (MIC) bits). Segmentation is not affected and is not used. Each mesh PDU for transmission using a Wi-Fi physical interface is prefixed with a predetermined header that distinguishes the PDU from conventional Wi-Fi traffic and indicates that the message is a mesh message. In at least one embodiment, the body of the Wi-Fi frames include an IEEE 802.2 Logical Link Control (LLC) header, a Subnetwork Access Protocol (SNAP) extension, and a message type. The LLC header identifies the SNAP extension, and the SNAP extension indicates a vendor unique identifier. In an embodiment, the mesh message type is one byte and ‘0’ indicates a mesh beacon, and ‘1’ indicates a concatenated mesh message, which may include only one segment. In other embodiments, other Wi-Fi frame configurations are used.

In at least one embodiment of network 640, each subnetwork has a corresponding predetermined network key index value. In at least one embodiment of network 640, rather than use the corresponding predetermined network key index values, wireless communications device 602 broadcasts dynamically allocated network key index values to each subnetwork. In at least one embodiment, subnetwork 0 is a primary subnetwork that has a network key index of ‘0’ and subnetwork 1 is a mesh Wi-Fi subnetwork having a network key index of ‘1,’ although other network key indices and other subnetworks may be used.

In at least one embodiment of network 640, nodes in subnetwork 1 omit GATT proxy advertisements for subnetwork 1. In at least one embodiment, the configuration manager enables GATT proxying with node identity on a per-subnetwork basis and disables GATT proxy advertisements for subnetwork 1. In at least one embodiment of network 640, Bluetooth mesh friendship traffic is contained within a subnetwork, thus there is no need to differentiate between friend-low-power node traffic over different physical interfaces within a subnetwork.

In at least one embodiment of network 640, subnetwork BR is a translation point between the Bluetooth mesh subnetwork and Wi-Fi subnetwork, and nodes of subnetwork BR include dual physical interface capabilities and translation mechanisms, which are discussed further below. Nodes of subnetwork BR include a dual-physical interface software stack that differentiates the source or destination physical interface without needing to change all stack-internal APIs to carry the physical medium information.

In at least one embodiment of network 640, a sender of a message from subnetwork 1 is aware of the Bluetooth physical interface of a destination node. In other embodiments of network 640, a sender of a message from subnetwork 1 does not know for certain whether a destination node is in subnetwork 1. The destination node may have an address bridged to another subnetwork. Accordingly, to send a large message, additional techniques are used.

In response to receiving segmented messages from subnetwork 0 destined for subnetwork 1, a bridging node collects segments, concatenates those segments, and sends the concatenated segments in a single Wi-Fi message to subnetwork 1. Conversely, in response to receiving from subnetwork 1 a Wi-Fi message destined for subnetwork 0, the bridging node segments the message into BLE mesh segments and individually transmits each segment to subnetwork 0. The sending node of subnetwork 1 uses a concatenated segments PDU that includes a predetermined header that distinguishes it from a regular Wi-Fi physical interface message. In an embodiment of a bridging node, a concatenated segments packet data unit is detected by comparing packet headers to the predetermined header. The concatenated segments PDU includes one or more 16-byte segmented access messages, which when reassembled will constitute a full upper transport PDU. In an embodiment, since each segment can include up to 8 bytes of the access payload, and the maximum payload size is 380 bytes plus a message integrity code (MIC) of 4 bytes, up to 48 segments may be concatenated into a single concatenated segments PDU, totaling 768 bytes.

In an embodiment, the concatenated segments PDU has the same fields as a regular network PDU, but a Transport PDU field of the concatenated segments PDU can include up to 768 bytes of concatenated segments. In addition, since the messages are usually large, the NetMIC size is forced to be 64 bits, which simplifies determining where the last segment ends and where the NetMIC field begins as compared to allowing MIC fields of varying sizes. Exemplary fields of a concatenated segments PDU are summarized in the table below.

| Field name | Size | Description |
|---|---|---|
| IVI | 1 bit (b) | Least significant bit of IV Index |
| NID | 7 b | (see NID from [1]) |
| CTL | 1 b | Network Control |
| TTL | 7 b | Time To Live |
| SEQ | 3 Bytes (B) | Sequence number |
| SRC | 2 Bs | Source address |
| DST | 2 B | Destination address |
| ConcatenatedSegments | 16 B × 1 . . . 48 (*) | Segmented Access Message segments |
| NetMIC | 8 B | Message integrity check |

(*) last segment may be shorter.

In at least one embodiment, when a bridging node receives a concatenated segments PDU, the bridging node individually sends each segment of the ConcatenatedSegments field to the Bluetooth mesh physical interface using regular Network PDUs, just as if it had received them individually. In response to receiving segment acknowledgment messages, the sending node of a concatenated segments PDU records the acknowledgments in the same way it records acknowledgments for regular segmented messages. In an embodiment, the sending node waits for a predetermined amount of time for more acknowledgments, and if the receiver is missing some segments, the sending node will send out another concatenated segments PDU that includes only the segments that were missing acknowledgments. This procedure continues until all segments are acknowledged, or the sending node times out the transmission.

In at least one embodiment, nodes in subnetwork 0 are commissioned and operate consistent with the Bluetooth mesh protocol and are unaware of the multi-protocol mesh network (or other non-standardized) mechanisms in the network. In at least one embodiment, a newly provisioned node is provided the network key index for subnetwork 1 via a standard configuration client model message (e.g., config Netkey Add message). Additionally, if the network key index of subnetwork 1 is not predetermined, the node must be informed about the network key index via a vendor model message.

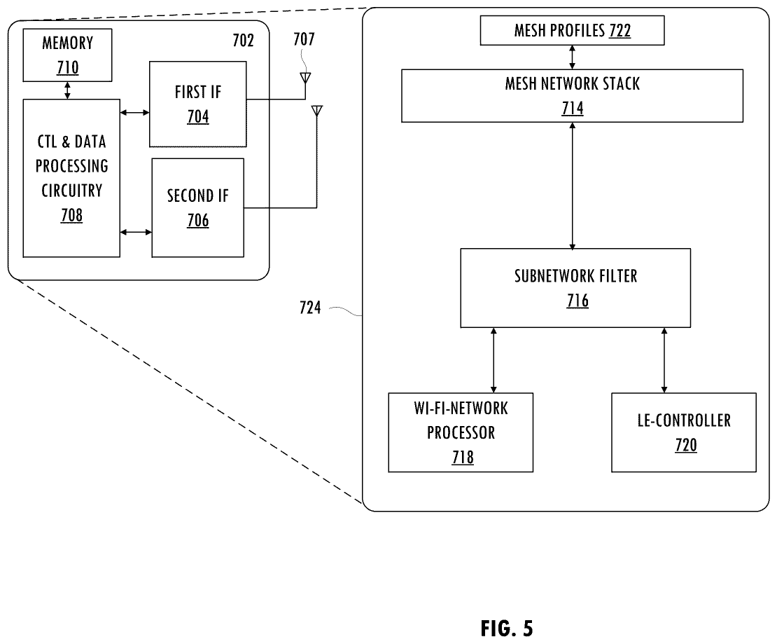

Referring to FIGS. 4 and 5, in at least one embodiment, bridge nodes 612, 614, and 616, are embodiments of multi-protocol node 702, which includes first interface 704 and second interface 706. First interface 704 is a low-power, low-throughput wireless communications interface compliant with the BLE communications protocol or the BLE High Data Throughput (BLE HDT) communications protocol, IEEE 802.15.4 or other protocol designed for low power and low latency applications. Second interface 706, is a high-power, high-throughput wireless communications interface compliant with IEEE 802.11 or other high-throughput wireless communications interface. For example, Bluetooth protocols have a throughput on the order of Mega-bits-per-second and Wi-Fi protocol has a throughput on the order of Giga-bits-per-second.

Control & data processing circuitry 708 may perform a variety of functions (e.g., logic, arithmetic, etc.). For example, control & data processing circuitry 708 may use demodulated data in a program, routine, or algorithm (whether in software, firmware, hardware, or a combination thereof) to perform desired control or data processing tasks. In at least one embodiment, control & data processing circuitry 708, which includes memory 710, controls other circuitry, sub-system, or systems (not shown). In an embodiment, control & data processing circuitry 708 implements layers of software stacks including state machines, state transitions, packet formats, scheduling, radio control, and link-layer decryption consistent with wireless communications protocols implemented by node functional model 724.

In an embodiment, node 702 implements Wi-Fi network processor 718, LE-controller 720, and mesh network stack 714 (e.g., using first interface 704, second interface 706, and corresponding instructions for software stacks stored in memory 710 and configured to execute on one or more processor included in control and data processing circuitry 708). Mesh network stack 714 provides network security, onboarding and configuration, network addresses, packet filtering, and routing consistent with a mesh network protocol (e.g., BLE mesh network protocol). Mesh profiles 722 include profiles for specific applications of the hybrid mesh network (e.g., BLE mesh including a Wi-Fi subnetwork). For example, a profile for a hybrid mesh network will provide for large PDUs and data rates not otherwise available in lightweight mesh networks. In at least one embodiment, a receiver process of Wi-Fi network processor 718 is always enabled (e.g., single channel) and a transmit process is enabled to transmit on-demand (e.g., using a single channel). In an embodiment, Wi-Fi network processor 718 is configured to operate using a Wi-Fi three address format (e.g., Destination Address (DA), Source Address (SA), and Basic Service Set Identifier (BSSID)). In at least one embodiment, a receiver process of LE-controller 720 is always enabled (e.g., LE-Scan) and a transmit process of LE-controller 720 is enabled on demand (e.g., LE-advertisement).

In an embodiment, node 702 implements LE-controller 720 corresponding to first interface 704 and Wi-Fi network processor 718 corresponding to second interface 706. In an embodiment, Wi-Fi network processor 718 and LE-controller 720 independently determine availability of the corresponding physical channel for communications and initiate transmission of data on the corresponding physical channel, accordingly. For example, Wi-Fi network processor 718 and LE-controller 720 independently forward a corresponding packet of data to first interface 704 or second interface 706, respectively, for transmission over the corresponding physical channel if the corresponding physical channel is available for communications.

In an embodiment, node 702 implements subnetwork filter 716, which manages traffic communicated over physical channels of coexisting communications protocols. In an embodiment, subnetwork filter 716 determines which addresses are available on a port, stores that information in a table, and forwards packets according to the information stored in the table (e.g., using a port corresponding to an address identified by a packet). In at least one embodiment, data packets are communicated using the higher-throughput protocol and control packets are communicated using the lower throughput protocol. In at least one embodiment, subnetwork filter 716 translates traffic (e.g., commands or attribute updates) received from mesh network stack 714, which is formatted consistent with the BLE wireless communications protocol and associated with a primary protocol identifier and forwards the translated traffic using a secondary protocol identifier to Wi-Fi network processor 718. Similarly, subnetwork filter 716 translates traffic received using the Wi-Fi communications protocol and associated with a secondary protocol identifier to a format consistent with the BLE wireless communications protocol and associated with a primary protocol identifier. Subnetwork filter 716 translates traffic (e.g., commands or attribute updates) received from Wi-Fi network processor 718 to a format consistent with BLE and forwards the translated traffic to mesh network stack 714. In at least one embodiment, subnetwork filter 716 forwards to LE-controller 720, unchanged, other traffic (e.g., commands or attribute updates) received from mesh network stack 714 and associated with a primary protocol identifier. Subnetwork filter 716 forwards to mesh network stack 714, unchanged, other traffic received from LE-controller 720 and associated with a primary protocol identifier.

Referring to FIG. 4, in at least one embodiment, each node of network 640 is configurable in a friend configuration (i.e., as a “friend node”) or in a low power configuration (i.e., as a “low-power node”) to operate within network 640 at a reduced receiver duty cycle. Reducing the time the receiver in a low power node is on reduces power consumption of the low power node and the low power node enables its receiver only when necessary. In general, a friend node assists a low power node by storing messages destined for the low power node. The friend node only forwards stored messages to the low power node in response to a request from the low power node. In an embodiment, a multi-protocol node is configured as a low power node (e.g., disables its receiver) and establishes friendship with another node that is configured as a friend node. The friend node keeps its receiver on and buffers data directed to the multi-protocol node while the receiver of the multi-protocol node is disabled. The multi-protocol node wakes up periodically and polls the friend node for any buffered data.

Since Wi-Fi receivers consume more power than BLE receivers, in at least one embodiment of network 640, power consumption is reduced in idle conditions by selectively enabling and completely disabling hybrid mesh network features. For example, a node disables Wi-Fi network processors of any bridge nodes in network 640 and configures the nodes of subnetwork 1 to operate using only the BLE wireless communications protocol. The BLE mesh network maintains connectivity while any Wi-Fi features enter a low power state. In response to an application requiring high throughput, a node sends a wake-up indication to all multi-protocol nodes in network 640 to enable Wi-Fi network processors in the multi-protocol nodes and to configure those multiprotocol nodes to re-establish the hybrid mesh network communications (e.g., reestablish a bridge subnetwork and a subnetwork using Wi-Fi communications).

In an embodiment, nodes of subnetwork 1 (e.g., 618, 620, 622, 624, and 626) establish a cross-protocol friendship with peers using BLE (e.g., nodes 606, 608, 610,612, 614, or 616). The cross-protocol friendship operates consistent with BLE mesh friendship but announces low power status of Wi-Fi communications (e.g., buffered data status) on subnetwork 1. If no data traffic exists in network 640, Wi-Fi-network processors of subnetwork 1 are configured in a low-power state (e.g., the Wi-Fi physical interface is disabled) and dual interface nodes of subnetwork 1 are configured to operate only using BLE mesh protocol. In some embodiments, the low power state disables any nodes of subnetwork 1 that only use Wi-Fi communications. In other embodiments, at least one node that uses only the Wi-Fi communications protocol or a multi-protocol node maintains the Wi-Fi network processor as always enabled, and other nodes configured in a low power state need not maintain the cross-protocol friendship with that node but do maintain a regular BLE mesh friendship with BLE nodes or multi-protocol nodes that disable the Wi-Fi operations. If data traffic begins or resumes buffering, subnetwork 1 exits the low-power state and begins or resumes regular operations (e.g., enables or wakes-up Wi-Fi operations of subnetwork 1).

In at least one embodiment, a multi-protocol node is configured to operate as a conventional Wi-Fi station and is configured as a node in a hybrid mesh network. The hybrid mesh network configuration is more robust than a conventional Wi-Fi network with multiple access points in an environment where all stations within range of a single access point may go offline. For example, in response to detecting failure of an access point to connect to any station, the multi-protocol node forms a hybrid mesh network that extends the network with a neighboring multi-protocol node, which connects successfully to a station. The multi-protocol node that is coupled to the access point and the localized hybrid mesh network serve as a bridge between the hybrid mesh network and cloud connectivity.

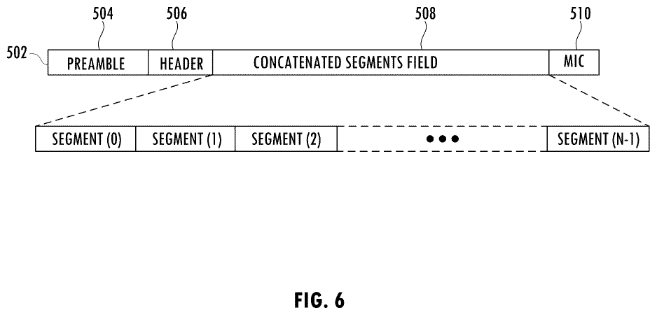

In at least one embodiment, Wi-Fi network processor 718 receives packets, consumes the preamble, header, and MIC, and provides a concatenated segments field to subnetwork filter 716. Referring to FIGS. 5 and 6, in at least one embodiment, the Wi-Fi network processor communicates packets having format 502, which includes preamble 504, header 506, and MIC 510 consistent with a Wi-Fi protocol, and includes concatenated segment field 508. Subnetwork filter 716 forwards PDUs of a plurality of BLE packets for transmission using the Wi-Fi protocol to Wi-Fi network processor 718 and Wi-Fi network processor 718 concatenates them to form concatenated segments field 508 of a Wi-Fi packet for transmission. Wi-Fi network processor 718 provides only concatenated segments field 508 to subnetwork filter 716. In an embodiment, subnetwork filter 716 partitions concatenated segments field 508 of packets received from the Wi-Fi network processor 718 and provides segments to mesh network stack 714. Packets for transmission using the BLE protocol are forwarded unchanged by subnetwork filter 716 between LE-controller 720 and mesh network stack 714.

Thus, techniques for establishing a high throughput mesh of nodes using a Wi-Fi physical interface and a BLE physical interface are described. The techniques may be implemented using software executing on a processor (which includes firmware) or by a combination of software and hardware. Software, as described herein, may be encoded in at least one tangible (i.e., non-transitory) computer readable medium. As referred to herein, a tangible computer-readable medium includes at least a disk, tape, or other magnetic, optical, or electronic storage medium.

The description of the invention set forth herein is illustrative and is not intended to limit the scope of the invention as set forth in the following claims. The terms “first,” “second,” “third,” and so forth, as used in the claims, unless otherwise clear by context, are to distinguish between different items in the claims and do not otherwise indicate or imply any order in time, location, or quality. For example, “a first received signal” and “a second received signal,” do not indicate or imply that the first received signal occurs in time before the second received signal. Variations and modifications of the embodiments disclosed herein may be made based on the description set forth herein, without departing from the scope of the invention as set forth in the following claims.

What is claimed is:

1. A method for operating a wireless mesh network of nodes, the method comprising:
receiving packets from a mesh network stack of a first wireless communications protocol executing on a bridge node of the wireless mesh network;
translating the packets from the first wireless communications protocol to a second wireless communications protocol by the bridge node, thereby generating translated packets; and
transmitting the translated packets by the bridge node using the second wireless communications protocol,
wherein the second wireless communications protocol has higher data throughput than the first wireless communications protocol.

2. The method as recited in claim 1, wherein translating the packets includes assembling a plurality of segments of the packets in a concatenated segments field of a concatenated segments packet data unit of the translated packets.

3. The method as recited in claim 1 further comprising:
receiving second packets from a second node of the wireless mesh network by the bridge node using the second wireless communications protocol;
identifying the second packets as being communicated using the second wireless communications protocol in response to detecting at least one concatenated segments packet data unit in the second packets;
translating the second packets from the second wireless communications protocol to the first wireless communications protocol by the bridge node partitioning a plurality of segments in a concatenated segments field of the at least one concatenated segments packet data unit into protocol data units of second translated packets; and
providing the second translated packets to the mesh network stack.

4. The method as recited in claim 3
wherein the second node is included in a first subnetwork of the wireless mesh network and a third node of the wireless mesh network is included in a second subnetwork of the wireless mesh network,
wherein the first subnetwork of the wireless mesh network is associated with a first predetermined network key index and the third node of the wireless mesh network is associated with a second predetermined network key index.

5. The method as recited in claim 1 further comprising:
receiving additional packets from the mesh network stack; and
transmitting the additional packets by the bridge node using the first wireless communications protocol,
wherein the translated packets are data packets and the additional packets are control packets.

6. The method as recited in claim 1 further comprising:
establishing friendship with a second node using the first wireless communications protocol;
buffering data destined for the bridge node by the second node during a low power state of operation; and
disabling communications using the second wireless communications protocol by the bridge node in the low power state of operation and communicating radio frequency signals using the first wireless communications protocol in the low power state of operation.

7. The method as recited in claim 1 further comprising:
enabling communications using the second wireless communications protocol by the bridge node in response to pending data for communication via the second wireless communications protocol.

8. The method as recited in claim 1 wherein the first wireless communications protocol is compliant with Bluetooth Low Energy standard or an Institute of Electrical and Electronics Engineers (IEEE) 802.15.4 standard and the second wireless communications protocol is compliant with an IEEE 802.11 standard.

9. An apparatus comprising:
a multi-protocol node comprising:
a first physical layer of a first protocol stack, the first physical layer being configured to communicate radio frequency signals using a first wireless communications protocol;
a second physical layer of a second protocol stack, the second physical layer being configured to communicate second radio frequency signals using a second wireless communications protocol; and
a subnetwork filter configured to receive a stream of packets from a mesh network stack, and to cause the second physical layer to transmit translated packets using the second wireless communications protocol.

10. The apparatus as recited in claim 9 wherein the subnetwork filter is configured to:
receive concatenated segments fields of second packets from the second physical layer;
partition a plurality of segments in each of the concatenated segments fields; and
provide each segment of the plurality of segments to the mesh network stack.

11. The apparatus as recited in claim 9 wherein the subnetwork filter is configured to:
receive additional packets from the mesh network stack; and
provide the additional packets to a controller for transmission using the first wireless communications protocol,
wherein the translated packets are data packets and the additional packets are control packets.

12. The apparatus as recited in claim 9 wherein first packets of the stream of packets are translated from the first wireless communications protocol to the second wireless communications protocol by assembling a plurality of segments of the first packets in a concatenated segments field of a concatenated segments packet data unit of the translated packets.

13. The apparatus as recited in claim 9 wherein first packets of the stream of packets are translated from the first wireless communications protocol to the second wireless communications protocol in response to a virtual network identifier of the first packets being a first predetermined network key index.

14. The apparatus as recited in claim 13 wherein a second virtual network identifier of additional packets of the stream of packets is a second predetermined network key index and the subnetwork filter is further configured to the first physical layer to transmit the additional packets using the first wireless communications protocol.

15. The apparatus as recited in claim 14 further comprising:
a second node associated with a first subnetwork of a wireless mesh network of nodes and configured to communicate using the first wireless communications protocol and the first predetermined network key index; and
a third node associated with a second subnetwork of the wireless mesh network and configured to communicate using the second wireless communications protocol and the second predetermined network key index.

16. The apparatus as recited in claim 15 wherein the second wireless communications protocol has higher data throughput than the first wireless communications protocol.

17. The apparatus as recited in claim 16
wherein the multi-protocol node is configured to disable the second physical layer in a low power state of operation and configured to communicate the radio frequency signals using the first physical layer in the low power state of operation, and
wherein the second node is configured as a friend node and to buffer data for transmission to the multi-protocol node during the low power state of operation.

18. A method for operating a wireless mesh network, the method comprising:
receiving a packet from a first physical layer associated with a first wireless communications protocol;
translating the packet from the first wireless communications protocol to a plurality of packets of a second wireless communications protocol by a bridge node of the wireless mesh network; and
providing a translated packet to a mesh network stack of the bridge node, the mesh network stack being associated with the second wireless communications protocol,
wherein the first wireless communications protocol has higher data throughput than the second wireless communications protocol.

19. The method as recited in claim 18 further comprising:
receiving a second packet from a second physical layer associated with the second wireless communications protocol; and
providing the second packet to the mesh network stack of the bridge node, the mesh network stack being associated with the second wireless communications protocol.

20. The method as recited in claim 18 further comprising:
transmitting the translated packet to a third node of the wireless mesh network using the second wireless communications protocol, the third node being associated with a second subnetwork of the wireless mesh network.
